(19) United States
(12) Patent Application Publication
(10) Pub. No.: US 2009/0246087 A1
(43) Pub. Date: Oct. 1, 2009

(54) MICROTITER PLATE FOR LONG-TERM STORAGE

(76) Inventors: Martin Pfeifer, Eimeldingen (DE); Guenther Scheel, Bad Krozingen (DE)

Correspondence Address: NOVARTIS INSTITUTES FOR BIOMEDICAL RESEARCH, INC., 220 MASSACHUSETTS AVENUE, CAMBRIDGE, MA, 02139, US

(21) Appl. No.: 12/303,025

(22) PCT Filed: May 30, 2007
(86) PCT No.: PCT/EP2007/055274

§ 371 Date: Dec. 1, 2008

Related U.S. Application Data
(60) Provisional application No. 60/940,510, filed on May 30, 2006.

(51) Int. Cl. B01L 3/00

(52) U.S. Cl. 422/102

(57) ABSTRACT

The invention relates to a microtiterplate appropriate for long-term storage of a high number of compound solutions. The invention more specifically relates to a microtiterplate for long-term storage, comprising: a) a frame (10) supporting: i) a matrix of wells (11) presenting a top surface, ii) liquid-receiver peripheral chambers (20) surrounding the matrix of wells, iii) a groove (16) peripheral to the liquid-receiver chambers, being defined by inner and outer side walls, and, b) a cover (30) for enclosing the matrix of wells and liquid-receiver peripheral chambers, said cover comprising at least one protrusion which releasably engages into the groove, characterized in that the top of the inner and outer side walls of the peripheral chambers are in close contact with the cover, and the top surface of the matrix of wells is not in close contact with the cover, thereby defining a closed single space between the top surface of the matrix of wells and the cover.

The invention relates to a microtiter plate appropriate for long-term storage of a high number of compound solutions. The invention more specifically relates to a microtiter plate for long-term storage, comprising

(a) a frame (10) supporting
(i) a matrix of wells (11) presenting a top surface,
(ii) liquid-receiver peripheral chambers (20) surrounding the matrix of wells,
(iii) a groove (16) peripheral to the liquid-receiver chambers, being defined by inner and outer side walls, and,
   (b) a cover (30) for enclosing the matrix of wells and liquid-receiver peripheral chambers, said cover comprising at least one protrusion which releasably engages into the groove, characterized in that the top of the inner and outer side walls of the peripheral chambers are in close contact with the cover, and the top surface of the matrix of wells is not in close contact with the cover, thereby defining a closed single space between the top surface of the matrix of wells and the cover.

Microtiter plates or microplates are flat plates with multiple “wells” used as small test tubes. The microplate has become a standard tool for performing a large number of chemical or biological assays in parallel in applications such as analytic research, combinatorial synthesis or high throughput screenings. Microplates typically have 96, 384 or 1536 sample wells arranged in a 2:3 rectangular matrix. Each well of a microplate typically holds between a few to a few hundred microliters of liquid.

In 1996, the Society for Biomolecular Screening (SBS) began an initiative to create a standard definition of a microtiter plate. A series of standards was completed in 2003 and published by the American National Standard Institute (ANSI) on behalf of the SBS. The standards governs various characteristics of a microtiter plate including well dimensions (e.g. diameter spacing and depth) as well as plate properties (e.g. dimensions and rigidity).

A number of companies have now developed robots to specifically handle SBS microplates. These robots may be liquid handlers which aspirate or dispense liquid samples from and to these plates, or “plate movers” which transport them between instruments and incubators.

Instrument companies have also designed plate readers which can detect specific biological, chemical or physical events in samples stored in these plates.

While maintaining the SBS standard to be handled by corresponding robots and machines, the number of wells per microplate has been increased and consequently the volume of each well has been reduced. Microplates with 1536 wells typically have a well volume up to a maximum of ˜20 μl.

A main problem with those plates is that they are not appropriate for long term storage—beyond a few weeks or months—of small volume samples without active sealing of plate. Sealing of plates, however, is not compatible with multiple use (with the need for repetitive sealing/unsealing cycles) and robotized plate processing.

Alternatively, when plates are covered with removable covers and stored for long periods in environments exposed to frequent air flows, the following is observed:

(i) solvent evaporation driven by the differences in actual vapor pressure to saturation vapor pressure of a solvent at a given temperature. The extent can be derived from the Maxwell-Boltzmann distribution and the respective phase diagrams.
(ii) heterogeneous loss of solvent with a maximum close to the corners due to the so-called hydrodynamic paradox, where materials exposed to a flowing current are sucked into, instead of being pulled away from the current by creating a negative pressure or suction. The underlying principle, also called Venturi-effect, has numerous applications in industry. In the case of sample storage, however, this heterogeneous solvent evaporation makes individual wells unusable long before the total loss of solvent per plate gets to a significant extent and hence this is the most critical issue. Furthermore, wake turbulences along the sealing lines may occur. The size and impact of these wake turbulences is largely determined by surrounding wind speeds, geometrical factors and surface roughness. If those are located in close proximity to wells, relatively high wind speeds occur just above the well and thus create a suction which in turn leads to higher local evaporation.

Solutions to minimize evaporation have been proposed in the prior art. For example, U.S. Pat. No. 5,587,321 discloses a plate with liquid receiving chamber at the periphery of the matrix of wells. US2005/0048575 (Coassin et al) discloses a high density plate for storage, containing evaporation control wells at the periphery of the matrix. Coassin et al further reports the use of a cover which has a protrusion which engages into the trough formed in the plates peripheral to the matrix of wells. According to Coassin et al, this feature is deemed to create a labyrinth which increase the distance across which vapor has to diffuse, and thereby contributes to prevent evaporation.

However, none of these solutions are satisfactory for long term storage in the range of at least 4 to 12 months of a high number of chemical compounds solutions, with small sample volumes, in a microplate which could be used in a standard robotics incubator.

The present invention provides a simple and efficient solution to this problem. Specifically, the microplates of the invention provide, for the first time, storage for up to 6 months for a high number of compound solutions (e.g. compound solutions of 2 mM compound in DMSO/10% water), e.g., at least 1536 different samples stored in a standard rectangular 127.76×85.47 mm microtiter plate.

In a first aspect, the present invention relates to a microtiter plate for long-term storage, comprising

(a) a frame supporting
(i) a matrix of wells presenting a top surface
(ii) liquid-receiver peripheral chambers surrounding the matrix of wells, and
(iii) a groove peripheral to the liquid-receiver chambers, being defined by inner and outer side walls, and,
   (b) a cover for enclosing the matrix of wells and liquid-receiver peripheral chambers, said cover comprising at least one protrusion which releasably engages into the groove, characterized in that the top of the inner and outer side walls of the peripheral chambers are in close contact with the cover, and the top surface of the matrix of wells is not in close contact with the cover, thereby defining a closed single space between the top surface of the matrix of wells and the cover.

The side walls of the peripheral chambers could indeed be used advantageously to tightly seal the plates with the cover, creating a physical barrier for vapor diffusion and a single head space between the top surface of the matrix of wells and the cover. Such single volume provides at least the following two advantages:

a) it prevents the condensate typically forming under the cover from getting into contact with the well matrix which thus would lead to compound cross-contamination as well as hampered removal of the cover on automated devices due to cohesion; and,
b) it acts as an equilibrium space for wake turbulences or air currents to equilibrate and reduce their speed before coming into contact with the well matrix surface and in turn preventing the corner wells from becoming unusable long before the majority of a plates even experiences a significant evaporation.

One essential aspect of the invention is that the inner side wall of the peripheral chamber is in close contact with the cover. Because of insufficiencies of the manufacturing process as well as solvent uptake by polymers, commercially available microtiter plates and covers are inevitably warped and the contact line between the top of edges of the plate is never tightly sealed. Current production tolerances of less than 1/1000 mm still allow vapor to diffuse from the inside of a plate/cover to the surrounding environment. However, it is shown by the present invention that air exchange can be minimized as long as the ratio of the distance between the top surface of the matrix of wells and the cover divided by the maximum gap distance (measured at the contact line between the top of the inner side wall of the peripheral chambers) is as large as possible. Preferably, according to the present invention, the warping tolerance is controlled so that the distance between the top surface of the matrix of wells and the cover is at least twice, preferably at least four fold and more preferable at least ten fold larger than the maximum gap distance measured at the contact line between the top of the inner side wall of the peripheral chambers and the cover.

As used herein, the term “maximum gap distance” refers to the largest distance that can be measured at any point at the contact line between the top of the inner side wall of the peripheral chambers and the cover. Indeed, depending on the warping of the plate and covers, for each plate, this distance may vary from zero (0) at points where the cover is in direct contact with plate and hundreds of micrometers for the maximum distance.

Advantageously, the plates according to the invention are characterized in that any gap at the contact line between the top of the inner side wall and cover does not exceed 0.3 mm, preferably 0.2 mm, and more preferably 0.1 mm and the distance from the top surface of the matrix of wells and the cover is superior or equal to 1 mm, preferably 1.7 mm and preferably up to 10 mm, preferably as far as is compatible with the SBS standard plate height of 14.35 mm.

In a specific embodiment, the plate according to the invention is characterized in that the outer side wall of the liquid-receiver peripheral chamber is also the inner side wall of the trough and the inner side wall of the liquid-receiver peripheral chamber is also the outer side walls of the peripheral wells. In such embodiment, the peripheral chambers are adjacent to the peripheral wells of the matrix.

In order to prevent vapor diffusion the number of contact lines between the cover and the plate is increased. To this end, in a specific embodiment, the plate of the invention is characterized in that the side walls of the liquid-receiver peripheral chambers and the groove of the plate are in close contact with the cover, thereby defining at least three contact lines preventing vapor diffusion, such that any gap in each contact line does not exceed 0.15 mm.

According to the invention, the plates include liquid receiver chambers surrounding the matrix of wells. One moat surrounds the matrix of wells which can be filled with liquid, e.g. by using manual pipetting devices. Advantageously, the space between the liquid and the cover defines a closed space distinct from the space between the top of the wells and the cover. The presence of liquid in the chamber provides a saturated atmosphere, thereby avoiding vapor diffusion from the wells to the outside environment. In specific embodiments, the moat surrounding the matrix of wells is divided into multiple sections by side walls in order to stop mechanical shockwaves and prevent spillage.

In one specific embodiment, the plates are characterized in that the interior volume of each peripheral chamber is larger than the interior volume of each well, preferably at least twice the interior volume of a well, more preferably at least four fold the interior volume of a well.

The microplates are preferably appropriate for long term storage of a high number of samples. As used herein, “long term storage” means for example that, in each well of a microplate according to the invention, containing 6 μL of DMSO, less than 50% of the volume of the stored solutions, preferably less than 30% and more preferably less than 10% can evaporate from the corner wells after 3 months of storage in a standard incubator without sacrificial solvent being filled into the peripheral chambers, and less than 15% and preferably less than 5% in total having been evaporated under the above mentioned conditions.

In one embodiment, the interior volume of each well is at least 2 μl or more, for example between 2 μl and 17 μl, or between 1 μl and 6 μl.

The number of wells is preferably a multiple of six, twelve, twenty-four or ninety-six, for example in specific embodiments 96, preferably at least 384, 768, 864, or most preferably at least 1536, 3456 or 6144 wells, arranged as a cluster. In one embodiment, the wells have square cross sections and the inner side of the wall defining the peripheral liquid receiver chambers also define the outer side of the peripheral wells of the matrix.

One advantage of the invention is that one can use standard dimension, e.g., ANSI dimensions to achieve microplates appropriate for long term storage of a high number of samples. Therefore, in one preferred embodiment, the plates of the invention are characterized in that the frame has a rectangular footprint of 127.7±0.25 mm×85.5±0.25 mm, for example 127.76×85.47 mm, or of slightly different dimensions, still appropriate for standard robots and incubators designed for plates with the standard dimensions of the SBS (Society of Biomolecular Screening). Such standard robots and incubators include for example, the principal plate handling robots from Velocity11, Stäubli, Beckman, Thermo Electron, Sysmelec, CRS, among others and the Automated MTP stores from Liconic and Thermo Electron Corp./Kendro among others.

The plate may have a height in the range between 5 mm and 20 mm, preferably between 9 and 15 mm.

The plate is preferably injection molded from DMSO-resistant material. For example, in one preferred embodiment, cyclo-olefin copolymer is used. The choice of the material may also depend on the production process of the plates, the dimensions of the plates and the solvent which could be used to fill the wells and the chambers. Examples of appropriate DMSO-resistant materials are cyclo-olefin polymer or cyclo-olefin copolymer, such as those described in U.S. Pat. No. 6,232,114.

In another specific embodiment, the inner side of the cover opposite the top surface of the matrix wells has a rough surface, thereby preventing the formation of large droplets by condensation. In a specific embodiment of the invention, the inner side of the cover opposed to top surface of the matrix wells has trumpet shape cones with their peaks reaching towards the center of any well, thereby acting as condensate returns.

However, the areas of the inner side of the cover opposite to openings of the peripheral chambers which are in close contact to the side walls thus forming the sealing lines are preferably smooth.

The invention will be explained in more detail using exemplary embodiments and the associated figures, in which:

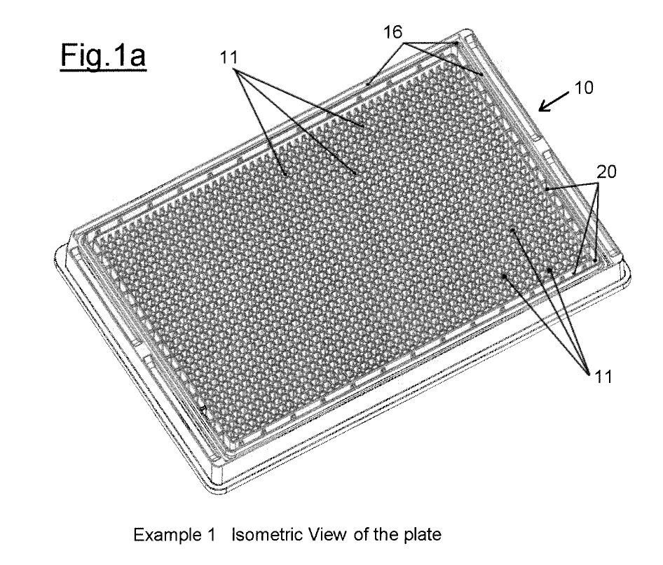

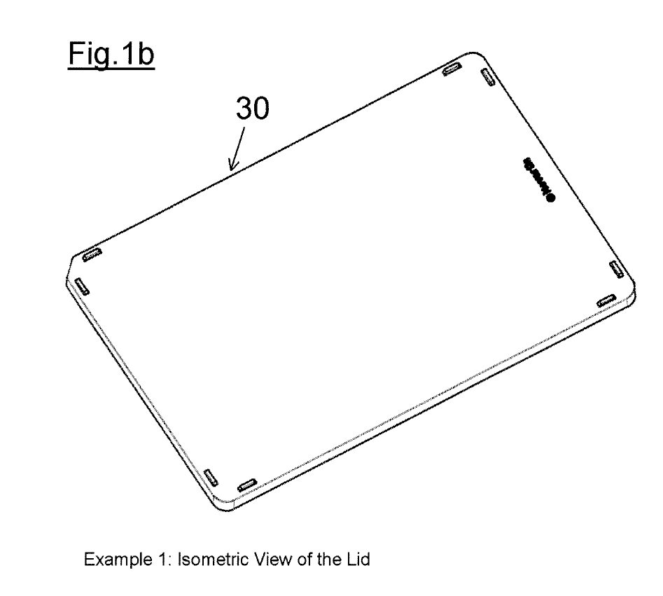

As shown in FIGS. 1a and 1b, the plates of the invention comprises a frame (10) supporting a matrix of wells (11) and a cover (30). The matrix of wells can be arranged in a rectangular configuration, comprising 32 rows and 48 columns in a 127.76×85.47 mm dimensioned frame, enabling 1536 well microtiter plates. Each well can have a square cross section, delimited by side walls and has a top opening. The plate have liquid-receiving chambers (20) surrounding the matrix of wells. In the specific example shown in FIG. 1a, the peripheral chamber make a turn in each corner so that it also prevents evaporation from the corners.

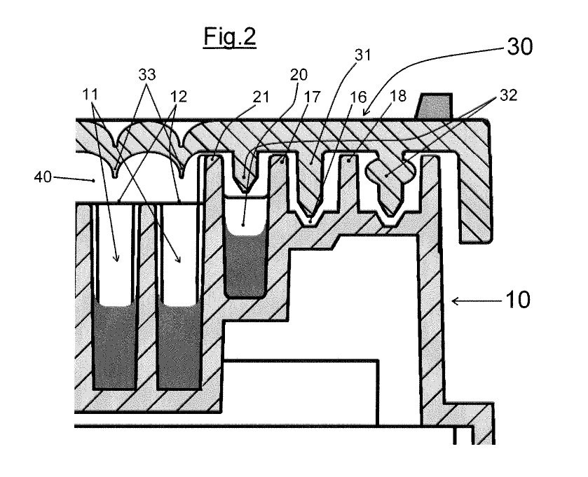

FIG. 2 represents a detail of a cross section of the edge region of a plate according to the present invention. It is possible to see that the inner side wall (21) of the peripheral chambers (20) is also the outer side wall of the peripheral wells (11). The wells open via their top openings (12) towards a closed space (40) further delimited by the cover (30) at the top and the inner side wall (21) of the peripheral chambers at the edges of the plate. The distance between the top openings of the wells (12) and the cover (30) can be around 1.7 mm. The top of the inner and outer side walls (17, 21) of the peripheral chambers are in close contact with the cover. Preferably, any gap between the cover and the top of peripheral chambers side walls does not exceed 0.15 mm. Further, the frame comprises a trough (16) peripheral to the chambers (20). It is shown in this specific example that the trough is defined by two side walls, the inner side wall of the trough (17) being the outer side wall of the liquid receiver chamber. The side walls of the trough (17, 18) and of the peripheral chambers (17, 21) define three parallel lines in close contact with the cover, with a maximum gap distance which does not exceed preferably 0.15 mm. A protrusion (31) from the cover which releasably engages with the trough can be seen. Any means to increase the labyrinth path length are appropriate to improve evaporation performance. For example, a second trough associated with a second protrusion from the cover is also present in this specific example as shown in FIG. 2 as well as another protrusion which releasably engages in the peripheral chamber (32). Any of these protrusions may also be equipped with swellings as shown in the external protrusion (32) or roughened. The maximum gap distance between the plate and the extremity of the protrusion also does not exceed preferably 0.4 mm.

The cover may also contain condensate returns (33) preferably with cone shape, more preferably formed like trumpet cones (peaks).

For long term storage, the liquid receiving chambers are filled with appropriate solvent, for example, preferably the same solvent as the solvent of the samples. Preferably, between 2 to 8 μl of sample volumes are filled within each well. All the wells can be filled with samples, including the peripheral wells (for example, 1536 wells). The plates are stored in an incubator, for example a Liconic StoreX1000, a Thermo Electron C44 or similar.

The production of the microplates of the invention can be carried out by any appropriate means known in the art, for example by injection molding of appropriate molding material. Methods to produce microplates in polyolefin copolymers are for example described in U.S. Pat. No. 6,503,456.

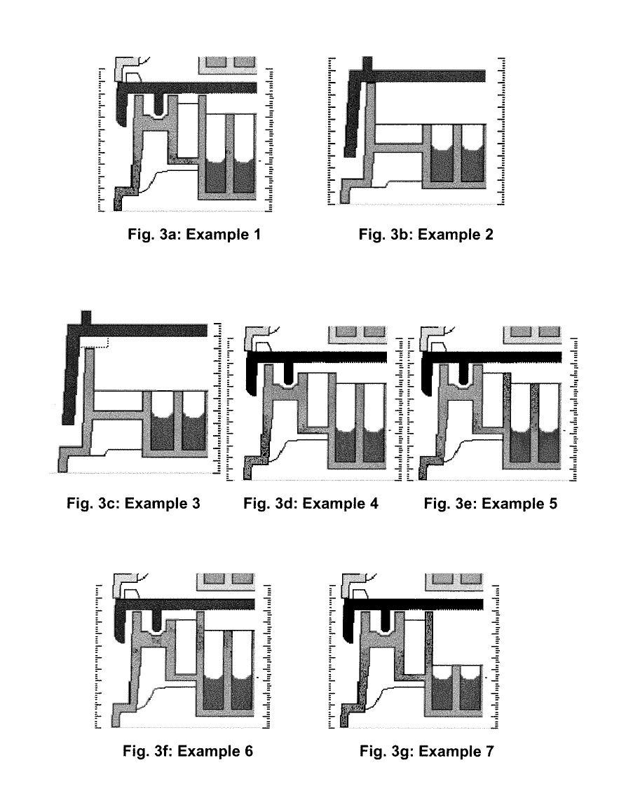

FIG. 3a-g represent a detail of a cross section of plates as described below in the Examples 1-7 respectively.

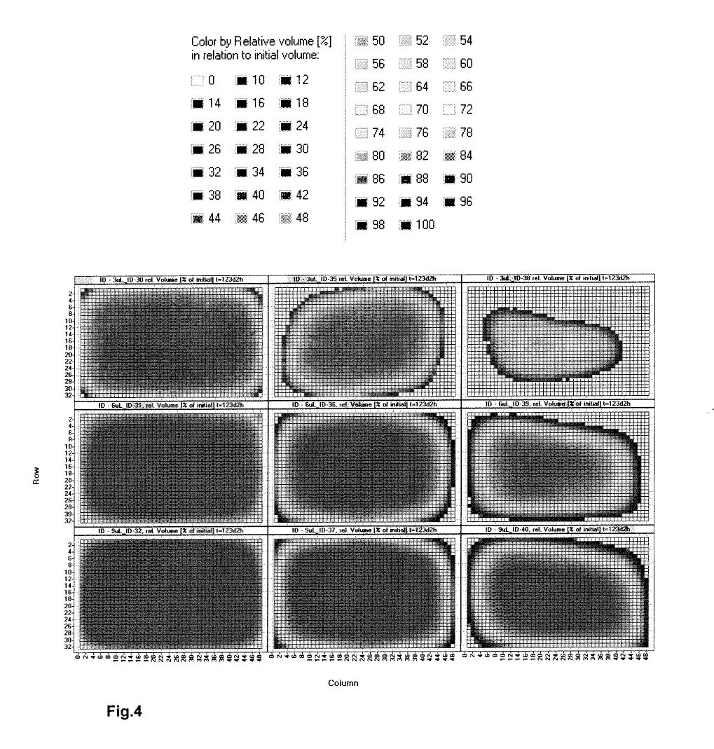

FIG. 4 represent evaporation rate after 4 months (120 days) of storage for each plate of examples 1-3 as described below, when all wells are filled with samples, but the peripheral chambers are not filled with liquid.

Left column: Example 1 (corresponding to the plate of the invention)
Medium column: Example 2
Right column: Example 3
Upper row: 3 μl of sample volume filled in each well
Medium row 2: 6 μl of sample volume filled in each well
Lower row: 9 μl of sample volume filled in each well

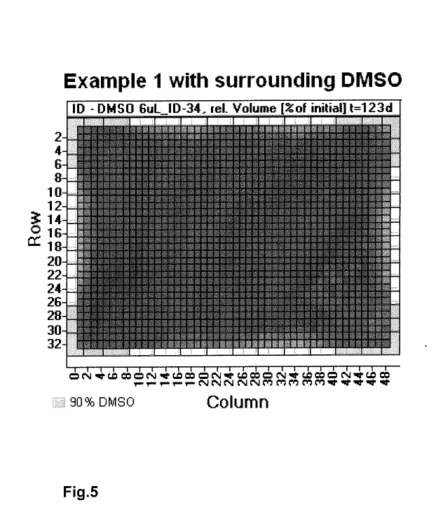

FIG. 5 represent the plate of example 1 and the evaporation rate after 4 months where certain liquid receiver chambers are also filled with DMSO (as shown by grey color corresponding to DMSO).

### COMPARATIVE EXAMPLES

### Evaporation Studies

The following 1536 well plates have been compared for their capacity to retain DMSO after long term storage. A cross section of the edge region of the plates according to examples 1-7 is shown in FIG. 3a-g respectively.

Example 1 is an example of 1536 microtiter plate according to the present invention as described in FIGS. 1 and/or 2 and FIG. 3a. The inner and outer side of the peripheral chambers and the trough is in close contact with the cover and the distance between the wells and the cover is 1.7 mm. The plates are made of COC, with a total volume per well of 16.25 μl.

Example 2 corresponds to a combination of a low evaporation plate design of Greiner (LoBase design equal to any plate type like Greiner #783xxx in example 783101 with custom injection molded with COC) together with a commercially available Remp cover (Lid Purple #23820-101 A28) as shown in FIG. 3b. Contrary to the present invention, the inner side of the peripheral chamber is not in close contact with the cover.

Example 3 is a custom COC 1536 microtiter plate made from a Greiner mold that is commonly used for the production of commercially available PS Low Base plates [LoBase design equal to any plate type like Greiner #783xxx in example 783101 with custom injection molded with COC] together with a commercially available Greiner Low Profile Cell Culture Lid (#656190). As shown in FIG. 3c, contrary to example 2, the outer side of the peripheral chamber is also not in close contact with the cover.

Example 4 is an example of a plate as shown in Example 1 except that the inner and outer sides of the peripheral chamber are not in close contact with the cover.

Example 5 is an example of a plate as shown in Example 1 except that only the inner and outer side of the groove are in close contact with the cover but not the inner side of the peripheral chamber. The distance between the inner side of the peripheral chamber and the cover is 1 mm.

Example 6 is an example of a plate as shown in Example 1 except that only the outer side of the groove and the inner side of the peripheral chamber are in close contact with the cover but not the outer side of the peripheral chamber. The distance between the outer side of the peripheral chamber and the cover is 1 mm.

Example 7 is an example of the plates according to the present invention as proposed in Example 1, except that the gap between the top of the wells and the cover is about 4.7 mm.

In all examples, a mixture of 90% DMSO and 10% water was added to all 1536 wells. SulforhodamineB (Sigma-Aldrich 230162-5G) was added to make a final concentration of 10 μM in order to colorize the solution for better visual tracking of the phenomena. Either 3 μL, 6 μL or 9 μL of this solution were filled into all wells of a plate species. One plate of the 6 μL series received in addition DMSO in the liquid receiver chambers close to the columns 1-8, 40-48 and the rows A-D and CC-FF, as shown in FIG. 5 in grey color. Meniscus measurements were performed using the survey function of an Echo550 acoustic dispenser (Labcyte Inc.). The time the sound travels between the top of the well bottom (polymer-to-liquid interface) and the liquid meniscus (liquid-to-air interface) was measured, converted into the fluid thickness height (fth) [mm] and correlated with the actual volume [μL] from the weight calibration. A standard curve with 1, 1.5, 2, 3, 5, 7, 9, 10 μL was produced and calibrated by weight measurements.

Plates were surveyed and then stored inside Liconic StoreX 1000 plate incubators at 10° C. and 10% rel. humidity for up to 4 months. Measurements were taken after 11 days, 30 days, 60 days, 90 days and 120 days.

### Results:

### Long-Term Storage of Examples 1-3

The results of evaporation rate for Examples 1-3, where each well is filled with 3 μL, 6 μL or 9 μL of this solution but the peripheral chamber remains unfilled are shown in FIG. 4. Evaporation rate of example 1 where the peripheral chambers are filled with DMSO is shown in FIG. 5. Data are also presented in the following Table 1.

TABLE 1

| | Example 1 | | | Example 1 + DMSO |
|---|---|---|---|---|
| Plate ID | 3 uL_ID-30 | 6 uL_ID-31 | 9 uL_ID-32 | 6 uL_ID-34 |
| Sum of Total evaporation rate over 4 months | 259 | 328 | 299 | 269 |
| [nL/plate and hour] | | | | |
| Sum of Total Volume loss over 4 months | 769 | 973 | 888 | 797 |
| [μL/plate] | | | | |
| Sum of evaporation rate of 3 adjacent wells | 0.7 | 1.4 | 2.1 | 1.1 |
| of all 4 corners (A1, B2, C3/A48, B47, C46/FF1, | | | | |
| EE2, DD3/FF48, EE47, DD46) [nL/h] | | | | |
| Sum of Total Volume loss of 3 adjacent wells | 2.0 | 4.1 | 5.9 | 3.1 |
| of all 4 corners (A1 ,B2, C3/A48, B47, C46/FF1, | | | | |
| EE2, DD3/FF48, EE47, DD46) [μL] | | | | |

| | Example 2 | | |
|---|---|---|---|
| Plate ID | 3 uL_ID-35 | 6 uL_ID-36 | 9 uL_ID-37 |
| Sum of Total evaporation rate over 4 months | 584 | 619 | 683 |
| [nL/plate and hour] | | | |
| Sum of Total Volume loss over 4 months | 1751 | 1835 | 2025 |
| [μL/plate] | | | |
| Sum of evaporation rate of 3 adjacent wells | 2.5 | 3.2 | 4.3 |
| of all 4 corners (A1, B2, C3/A48, B47, C46/FF1, | | | |
| EE2, DD3/FF48, EE47, DD46) [nL/h] | | | |
| Sum of Total Volume loss of 3 adjacent wells | 7.1 | 9.4 | 12.8 |
| of all 4 corners (A1, B2, C3/A48, B47, C46/FF1, | | | |
| EE2, DD3/FF48, EE47, DD46) [μL] | | | |
| | Example 3 | | |
| Plate ID | 3 uL_ID-38 | 6 uL_ID-39 | 9 uL_ID-40 |
| Sum of Total evaporation rate over 4 months | 1285 | 1276 | 1248 |
| [nL/plate and hour] | | | |
| Sum of Total Volume loss over 4 months | 3800 | 3785 | 3701 |
| [μL/plate] | | | |
| Sum of evaporation rate of 3 adjacent wells | 4.4 | 4.8 | 5.9 |
| of all 4 corners (A1 ,B2, C3/A48, B47, C46/FF1, | | | |
| EE2, DD3/FF48, EE47, DD46) [nL/h] | | | |
| Sum of Total Volume loss of 3 adjacent wells | 13.0 | 14.2 | 17.2 |
| of all 4 corners (A1, B2, C3/A48, B47, C46/FF1, | | | |
| EE2, DD3/FF48, EE47, DD46) [μL] | | | |

Plate Example 1 clearly shows the best performance at any dispensed volume and demonstrates the importance of its unique features.

These results also underline the need for monitoring of the relative localized evaporation rates instead of average total evaporation rates per plate which were frequently used in the past as the key parameter for control of evaporation in microtiter plates.

### Long-Term Storage of Examples 1, 4, 5, 6, 7:

The evaporations rates of the corner wells (except FF48 due to a misread well in one plate) of plate examples 1, 4, 5, 6 and 7 were summed up and compared. The results are shown in Table 2.

TABLE 2

| | 1-line | | | 3-lines matrix- | |
|---|---|---|---|---|---|
| | inner + middle | 2-lines inner | 2-lines middle | 3 mm milled | 3-lines Original |
| | milled Example 4 | milled Example 5 | milled Example 6 | Example 7 | Example 1 |
| Sum of Evaporation Rates | 5.3 | 4.5 | 4.1 | 2.6 | 3.9 |
| (A1, A48&FF1) [nL/h] t = 26d | | | | | |
| Sum of Evaporation Rates | 4.7 | 4.1 | 3.4 | 2.4 | 3.5 |
| (A1, A48&FF1) [nL/h] t = 54d | | | | | |

### Results:

Overall loss of volume is very comparable, but the profile of evaporation differs significantly for different plate/cover designs. Less than two sealing lines for instance lead to strong evaporation in the corner wells whereas removing the middle sealing line does not influence the total performance significantly.

Absence of sealing lines close to the matrix leads to a more pronounced evaporation profile whereas increasing the space above the matrix mitigates the profile and keeps the plate usable for longer periods.

1. A microtiterplate for long-term storage, comprising
(a) a frame supporting
(i) a matrix of wells presenting a top surface,
(ii) liquid-receiver peripheral chambers surrounding the matrix of wells,
(iii) a groove peripheral to the liquid-receiver chambers, being defined by inner and outer side walls, and,
(b) a cover for enclosing the matrix of wells and liquid-receiver peripheral chambers, said cover comprising at least one protrusion which releasably engages into the groove, characterized in that the top of the inner and outer side walls of the peripheral chambers are in close contact with the cover, and the top surface of the matrix of wells is not in close contact with the cover, thereby defining a closed single space between the top surface of the matrix of wells and the cover.

2. The plate according to claim 1, characterized in that the distance between the top surface of the matrix of wells and the cover is at least twice, preferably at least four and more preferably at least ten fold larger than the maximum gap distance measured at the contact line between the top of the inner side wall of the peripheral chambers and the cover.

3. The plate according to claim 1 characterized in that any gap at the contact line between the top of the inner side wall and cover does not exceed 0.3 mm, preferably 0.2, and more preferably 0.1 mm and the distance from the top surface of the matrix of wells and the cover is superior or equal to 1 mm, preferably 1.7 mm and preferably no more than 10 mm.

4. The plate according to claim 1 characterized in that the outer side wall of the liquid-receiver peripheral chamber is also the inner side wall of the trough and the inner side wall of the liquid-receiver peripheral chamber is also the outer side walls of the peripheral wells.

5. The plate according to claim 4, characterized in that the side walls of the liquid-receiver peripheral chambers and the groove of the plate are in close contact with the cover, thereby defining three contact lines preventing vapor diffusion, such that any gap in each contact line does not exceed 0.15 mm.

6. The plate according to claim 1 characterized in that the interior volume of each peripheral chamber is larger than the interior volume of each well.

7. The plate according to claim 1 wherein the interior volume of each well is at least 2 μl or more.

8. The plate according to claim 1 characterized in that the matrix of wells comprises 96, 384, 768 or 864 wells, and preferably at least 1536 or 3456 wells.

9. The plate according to claim 1 characterized in that the frame has a rectangular footprint of 127.7±0.25 mm×85.5±0.25 mm, for example a footprint of 127.76×85.47 mm.

10. The plate according to claim 1 characterized in that the height of the plate is in the range between 5 mm and 20 mm, preferably between 9 and 15 mm.

11. The plate according to claim 1 characterized in that it is made in a DMSO-resistant material, preferably polystyrene and more preferably cyclo-olefin copolymers.

12. The plate according to claim 1 wherein the inner side of the cover opposed to top surface of the matrix wells has a rough surface, thereby preventing the formation of large droplets by condensation.

13. The plate according to claim 12, wherein the inner side of the cover opposed to top surface of the matrix wells has trumpet shape cones with their peaks reaching towards the center of any well, thereby acting as condensate returns.

14. The use of the plate according to claim 1 for carrying out a large number of chemical or biological assays in parallel in applications such as analytic research, combinatorial synthesis or high throughput screening.
